(19) United States
(12) Patent Application Publication
(10) Pub. No.: US 2010/0173191 A1
(43) Pub. Date: Jul. 8, 2010

(54) Conductor Plate Protection for a Battery

(75) Inventors: Jens Meintschel, Bernsdorf (DE); Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/528,752

(22) PCT Filed: Feb. 23, 2008
(86) PCT No.: PCT/EP2008/001447

§ 371 Date: Mar. 9, 2010

(30) Foreign Application Priority Data
Feb. 27, 2007 (DE) 10 2007 010 738.4

(51) Int. Cl. H01M 2/00

(52) U.S. Cl. 429/163

(57) ABSTRACT

The invention relates to a vehicle battery, comprising a housing, a cell assembly arranged in the housing made up of battery cells, and a plate arranged in the electrical connector region of the cells for electrical connection of the cells. The battery also has support elements arranged inside the housing which, in the case of a deformation of the housing toward the plate by a deformation force acting on the housing, support the loading forces acting on the plate due to the deformation of the housing.

This application is a national stage of PCT International Application No. PCT/EP2008/001447, filed Feb. 23, 2008, which claims priority under 35 U.S.C. §119 to German Patent Application No. 10 2007 010 738.4, filed Feb. 27, 2007, the entire disclosure of which is herein expressly incorporated by reference.

The invention relates to a battery, especially a high voltage lithium ion battery or nickel metal hydride battery for a vehicle with hybrid drive or a fuel cell vehicle.

According to the state of the art, heat generated in the cells of lithium ion batteries (e.g., for hybrid drives or fuel cell vehicles) during charging and discharging must be diverted by a cooling operation. Due to the maximum allowable cell temperature of about 50° C., cooling is provided via the air conditioning circuit of the vehicle.

According to the state of the art, batteries are known where cells are cooled from the base by a cooling plate through which a coolant flows. The heat is conducted through separate heat conducting bars in the longitudinal direction of the cell. So as to conduct heat from the cells to the cooling plate, heat conducting bars of aluminum are provided between the cells, which bars are anchored in the cooling plate and divert the heat in the longitudinal direction of the cells. However, such a cooling plate provided with both heat conducting bars and also a covering sheet is elaborate and expensive.

The cells are thermally coupled to the heat conducting bars by a casting compound, with which the cell assembly is filled. The casting compound provides electrical insulation, and also fixes the cells in the cell assembly. The casting compound further equalizes gaps due to tolerance between the components of the cell assembly. Epoxy resin, polyurethane or silicone are for example used as casting compound. The casting compound thus has only a relatively low mechanical stability compared to the other components of the cell assembly.

A jacket-like sheet, which is also placed on the cooling plate, encloses the cells laterally, serves for heat diversion, and acts as a mold for the casting compound that fills the spaces between cells and heat conducting bars. The entire cell block is surrounded with the covering sheet and is cast by means of a heat-conductive casting compound. The covering sheet thereby simultaneously forms the casting mold.

After the casting, the so-called cell block or cell assembly forms a massive construction which is secured in the battery housing. After the installation of the interior of the battery, the housing cover is secured by screwing, riveting or welding. The housing of a battery thus typically comprises a base, a sidewall and a cover.

For connecting the electrical connector regions of the cells and possibly also for monitoring the functioning (e.g., charging or current removal) of the cells of a battery to which the present application relates, the battery has a plate (cell connection and/or monitoring plate), which is arranged in the interior of the housing in the electrical connector region of the cells.

A plate is a carrier element for electronic components. It is also called a conductor board or a printed circuit board, and serves for both the mechanical attachment and electrical connection of electronic components. The connection lines are usually produced by etching a thin layer of conductive material on an insulating base board, and the components are soldered onto these conductor paths.

The plate is sensitive to breakage due to its design, and is subjected to load forces in the case of deformation of the housing (e.g., during a frontal crash of a vehicle) with a corresponding battery, which forces are caused by the deformation force on the housing. The plate can thereby be damaged or destroyed, which also results in dangers. For example, high short circuit currents can lead to overheating, or electric arcs to the ignition of mixtures. With high voltage batteries, there is also the danger that the housing will be charged.

According to the state of the art, the insulation plates that are used to protect the plates in batteries, only prevent a direct contact of the housing and the current-conducting parts in the interior of the housing. Thus, deformations of the cells including the cell terminal and the housing result, as well as tearing of cell connectors. As a voltage of about 120 Volts or more is present with high voltage batteries, the formation of electric arcs and/or an overload of the cells results.

The high load acting on the plate from the housing in the case of deformation of the known batteries is thus disadvantageous and can lead to damage, destruction and danger.

One object of the invention is to provide a battery with improved deformation safety, for example in the case of a crash.

This and other objects and advantages are achieved by the battery according to the invention (especially a lithium ion battery or nickel metal hydride battery), with a housing, a cell assembly of battery cells arranged in the housing and a plate arranged in the interior of the housing in the electrical connector region of the cells, for electrically connecting the cells. According to the invention, the battery also has support elements arranged in the interior of the housing. In the case of a deformation of the housing toward the plate by a deformation force exerted from the outside of the housing, the load forces exerted on the plate by the deformation of the housing are supported by the support elements, to protect the plate.

The support elements can be formed to conduct the load forces either around the plate or through it.

In an advantageous embodiment of the invention, the support elements formed on the cell assembly for the force distribution are provided by support elements that pass through the plate. The support elements can be formed for a large-area placement of the housing on the cell assembly or for the force distribution by means of support elements on the cell assembly passing through the plate.

According to a feature of the invention, the support elements for diverting the load forces are formed on the side of the cell assembly that faces the plate.

According to another embodiment of the invention, the load forces are transmitted by support elements inserted in the plate in a movable manner. However, the load forces can also be transmitted by support elements that are fixed in the plate, wherein the support elements are for example fixed through a passage in the plate or are glued into the plate.

The support elements may be formed as individual elements, (for example as pins), or as a surface element (for example, a board). The board is advantageously arranged on the side of the plate turned away from the electrical connector region of the cells. The board can further comprise supports passing through the plate.

In another embodiment of the invention, the plate for the force flow of the load forces comprises support elements worked into or integrated in the plate. The support elements can thereby for example be formed as support lugs or as stable electrical components which are arranged on the plate, such as coils. The support elements can further be arranged on the side of the plate turned towards the electrical connector region of the cells, or on both the side of the plate that is turned towards the electrical connector region of the cells and the side of the plate that is turned away from the electrical connector region of the cells.

The support elements may be formed for punctiform, linear or areal load distribution within the battery.

In a further embodiment of the invention, the support elements are formed for supporting an essentially horizontally progressing deformation force or load force, and for this purpose are aligned in an essentially horizontal orientation, related to the installation position of the battery.

The following advantages are achieved by the invention:
electrical safety is ensured by a distribution of the force within the cell assembly, even in case of a crash;
the battery can be installed in crash-endangered installation spaces, for example of a motor vehicle;
the cell pole connectors are protected;
the cell connector plates are protected against damage or destruction, also with regard to conductor paths and components;
additional elaborate reinforcement measures at the housing can be omitted;
a high voltage battery for a hybrid motor vehicle will not lead to an electrical voltage on the housing by a contact between cell connector plates and battery housing in the case of deformation, e.g., a frontal crash;
the entire deformation is kept very low and cell poles are not deformed during contact of the battery housing with the cell connector plate;
the load force is guided over a broad cell assembly through the battery, so that the structure of the battery housing is thereby relieved;
forces can be guided through plates damage by means of support elements, without damage or destruction;
the electrical layout of cell connector plates is protected, and the electrical insulation is ensured;
pressure forces are taken on from the battery housing in the cell assembly for avoiding force peaks;
the cell terminals are protected against deformation, damage or destruction by means of support elements between the battery housing, the cell connector plate and the cell assembly;
electrical energy stores on the basis of cells, (e.g., battery cells and capacitors) are protected in crash-relevant vehicle zones by a force distribution by means of support elements within the battery housing while using the cell assembly for the force transfer;
support elements are used for the punctiform, linear or areal load distribution within a battery for its electrical and mechanical safety and stability; and
support elements which are part of a plate design or which can conduct forces through plates separately can be used as crash protection elements.

Other objects, advantages and novel features of the present invention will become apparent from the following detailed description of the invention when considered in conjunction with the accompanying drawings.

### BRIEF DESCRIPTION OF THE DRAWINGS

FIG. 1 is a vertical section through a battery according to the invention;

FIG. 2 shows support elements formed as individual elements;

FIG. 3 shows a support element formed as surface element; and

FIG. 4 shows a plate with integrated support elements.

### DETAILED DESCRIPTION OF THE DRAWINGS

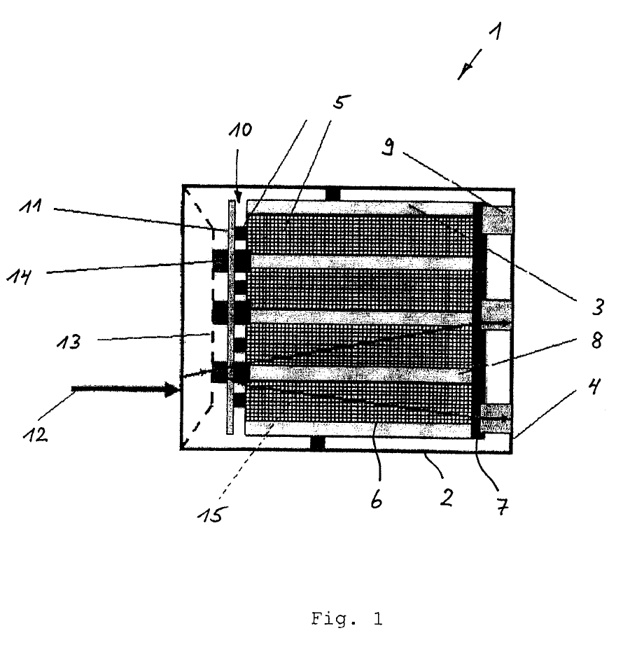

FIG. 1 shows a vertical section through a battery 1 according to the invention. Cells 5, for example lithium ion battery cells, inserted in the housing 2 comprising an interior housing 3 and an outer housing 4, can be seen. The cells 5 have a circular outer contour and are arranged in a cell assembly 6 with the longitudinal axes parallel to one another. To achieve a space-saving design, the cells 5 are arranged in a compact regular arrangement, possibly with a low distance between the cells 5, adjacent to one another in the cell assembly 5. The cells 5 can be cooled from the base by a cooling plate 7, through which a coolant flows in internally laid cooling coils. The cooling plate 7 has a coolant connection for passing a coolant through the cooling coils.

The entire cell block 5 can be surrounded with a covering sheet and can be filled with heat-conductive casting compound 8 prior to or after the insertion in the battery housing 2, which is not yet filled in FIG. 1. The casting compound 8 provides electrical insulation and fixes the cells 5 in the cell assembly 6. The cell assembly 6 is supported against the housing 2 by means of counter bearings.

The gaps or spaces which are present between the cells 5 are filled with casting compound 8. The covering sheet also serves as a casting mold during filling of the casting compound 8. The cell assembly 6 formed during the casting with casting compound 8 is built into the battery housing 2 after the casting. The casting compound 8 is preferably a heat-conductive and/or electrically insulating material. Suitable materials for the casting compound 8 are for example an epoxy resin, or a rigid or curing foam, especially a polyurethane foam.

A plate 11 (cell connection plate) is arranged in the electrical connector region 10 of the cells 5. The side of the plate 11 that faces the housing 2 can be filled with a casting compound 8.

If an external deformation force 12 acts on the battery housing 2, it may be deformed in the manner indicated by the dotted line. Due to the deformation 13, battery components arranged in the interior of the battery housing 2 may be contacted, and receive a load force originating from the deformation 13. According to the invention, support elements 14 (which may be, for example passage pins or support lugs in the shown embodiment) are provided to divert these forces. In this manner, the load force is kept away from the plate 11, which is thus protected. A force path 15 results, which is drawn in as an example.

thus, in the embodiment of FIG. 1, the deformation force 12 partially introduced via the battery housing 2 is conducted past the plate 11 or through it, and the housing 2 is placed in a large area on the cell assembly 6 or the support elements 14 passing through for the force distribution. Force conduction is provided via movable pins or boards inserted in the plate 11, via support lugs already included on the plates, or via stable electrical components such as coils. In the case of the included support lugs, the plate 11 can have them on both sides. Alternatively, the side turned towards the housing 2 may be protected electrically and mechanically, for example, by casting compound 8, to be able to carry the housing force in a large area.

FIG. 2 shows support elements 14 formed as individual elements. In the left half of FIG. 2, the support element 14 is mounted in the plate 11 in a movable manner. In the right half of FIG. 2, the support element 14 is fixed in the plate 11, for example via a fitting or by gluing.

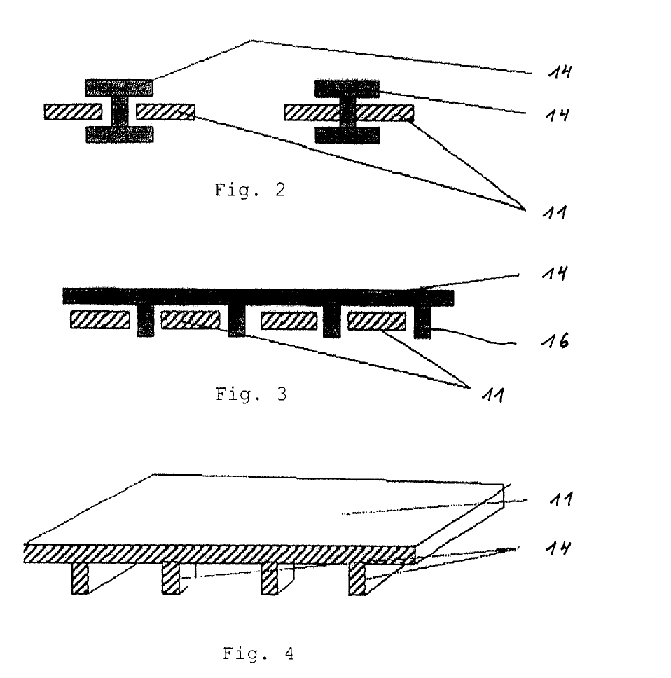

FIG. 3 shows a support element 14 formed as a surface element. It comprises a support plate for a large-area load admission and the support of the plate 11 takes place via supports 16 passing through openings in the plate 11. Such supports can, for example, be punctiform or linear, and are supported on the cell assembly 6.

FIG. 4 shows a plate 11 with integrated support elements 14, whose extension is dimensioned according to applicable requirements, and which can for example also be support lugs or components of the plate 11 (for example, coils).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-32. (canceled)

33. A battery comprising:
a housing;
a cell assembly of battery cells arranged in the housing;
a plate arranged in the interior of the housing in a connector region for the electrical connection of the cells; and
support elements arranged in the interior of the housing, which support elements are configured such that, in the case of a deformation of the housing toward the plate by a deformation force exerted on an outside on the housing, load forces exerted on the plate by said deformation of the housing are supported by the support elements, protecting the plate.

34. The battery according to claim 33, wherein the support elements are configured to pass the load forces around the plate.

35. The battery according to claim 33, wherein the support elements are configured to pass the load forces through the plate.

36. The battery according to claim 33, wherein the support elements are configured to distribute the force over a large area placing of the housing on the cell assembly.

37. The battery according to claim 33, wherein the support elements are configured to distribute the force by means of support elements passing through the plate on the cell assembly.

38. The battery according to claim 33, wherein the support elements are configured to divert the load forces on the side of the cell assembly facing the plate.

39. The battery according to claim 33, wherein the force flow of the load forces takes place via support elements mounted in the plate in a movable manner.

40. The battery according to claim 33, wherein the force flow of the load forces takes place via support elements fixed in the plate.

41. The battery according to claim 40, wherein the support elements are fixed through a passage in the plate.

42. The battery according to claim 40, wherein the support elements are glued into the plate.

43. The battery according to claim 33, wherein the support elements are formed as individual elements.

44. The battery according to claim 33, wherein the support elements comprise pins.

45. The battery according to claim 33, wherein the support elements are formed as a surface element.

46. The battery according to claim 45, wherein the support elements are formed as a board.

47. The battery according to claim 46, wherein the board is arranged on a side of the plate that faces away from the electrical connector region of the cells.

48. The battery according to claim 46, wherein the board has supports penetrating the plate.

49. The battery according to claim 33, wherein the plate comprises support elements that are connected to or integrated into the plate for the force flow of the load forces on the plate.

50. The battery according to claim 49, wherein the support elements are formed as support lugs.

51. The battery according to claim 49, wherein the support elements are formed as stable electrical components, which are arranged on the plate.

52. The battery according to claim 50, wherein the support elements are formed as coils.

53. The battery according to claim 49, wherein the support elements are arranged on a side of the plate which faces the electrical connector region of the cells.

54. The battery according to claim 49, wherein the support elements are arranged on the side of the plate that faces the electrical connector region of the cells, and on the side of the plate that faces away from the electrical connector region of the cells.

55. The battery according to claim 33, wherein the support elements are formed for punctiform load distribution within the battery.

56. The battery according to claim 33, wherein the support elements are formed for linear load distribution within the battery.

57. The battery according to claim 33, wherein the support elements are formed for the areal load distribution within the battery.

58. The battery according to claim 33, wherein the cells are arranged in a compact regular arrangement adjacent to one another.

59. The battery according to claim 33, wherein the cell assembly is filled with a casting compound.

60. The battery according to claim 33, wherein the side of the plate that faces the housing is filled with a casting compound.

61. The battery according to claim 59, wherein the casting compound is heat-conductive.

62. The battery according to claim 59, wherein the casting compound is electrically insulating.

63. The battery according to claim 33, wherein the support elements are formed for supporting an essentially horizontally progressing deformation force or load force and are aligned in an essentially horizontal orientation for this, related to the installation position of the battery.

64. The battery according to claim 33, wherein the battery is a vehicle battery for a vehicle with hybrid drive or a fuel cell vehicle.
